(19) United States
(12) Patent Application Publication
(10) Pub. No.: US 2003/0047936 A1
(43) Pub. Date: Mar. 13, 2003

(54) Statement folder (for credit and debit cards)

(76) Inventors: Rafael Jose Falcon, Weston, FL (US); Joel Johann Pinto, Miami, FL (US)

Correspondence Address: RAFAEL J. FALCON, 1323 PORTOFINO CIRCLE # 911, WESTON, FL, 33326, US

(21) Appl. No.: 09/949,545

(22) Filed: Sep. 10, 2001

(51) Int. Cl. B42D 15/00

(52) U.S. Cl. 283/62

(57) ABSTRACT

There are not technical secrets in our invention.

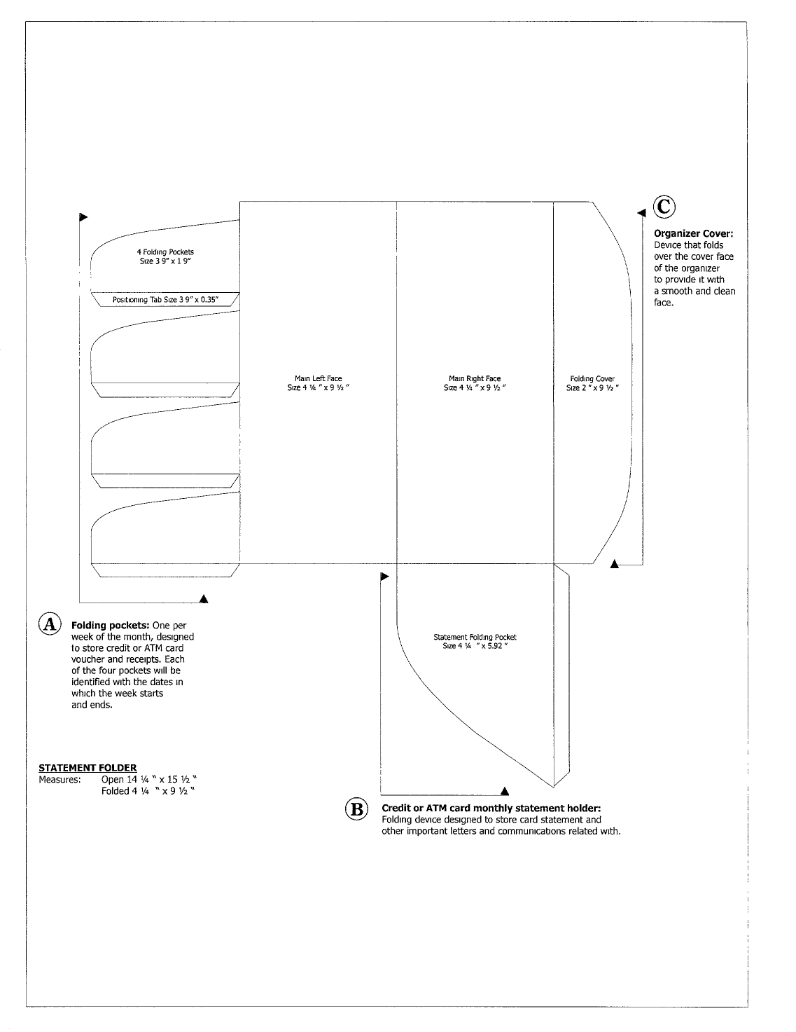

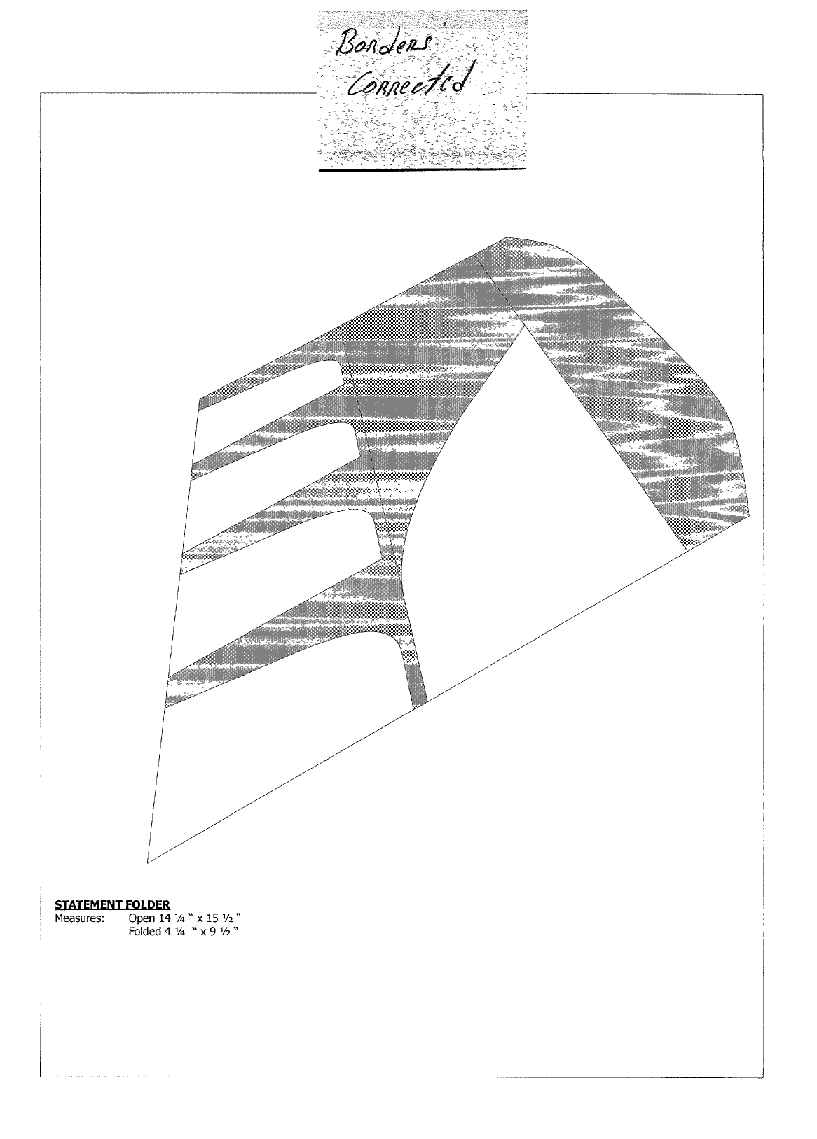

### BACKGROUND OF THE INVENTION

There are many ways to file a statement, voucher and receipts, but no one is intentionally designed to file the receipt, voucher and statement in the same organized folder. This invention will solve the problem of many credit card and debit cardholders that do not know where to file properly their vouchers and monthly statements. Many people keep their vouchers on a table, inside a bag, in their car's glove compartment, in a wallet or a purse, at many places but properly filed. This idea of design is to have a folder to file every voucher and a monthly statement in one place. This way people will not easily loose their receipt, it's corresponding monthly statement and it will also help them to better truck their billing and expenses information.

### BRIEF SUMMARY OF THE INVENTION

The STATEMENT FOLDER is a folder with a storage properly sized to keep vouchers and receipts in one side and statements (or bigger than voucher papers) in the other side to help organize expenses and bills. This new especially designed folder to help filing credit and debit card statement is though to be produce in many different size, types of material and color. It can be produced in paper to fit inside a regular letter envelope or in leather to be place on a desk. This folder can also be made to file a monthly statement, a full year statement or big enough to fit different account statement in one multiple folder. This simple idea could also be use for advertising, so that banks and other financial institutions can advertise their products stamped on the folder.

### DETAILED DESCRIPTION OF THE INVENTION

The folder will have two separate areas, one for receipts and vouchers and the other for statements. On the voucher side it will have one or more pockets for filing. It could be one pocket for a total month or more than one to divide the monthly expenses in weeks or even days. In our particular sample we placed in four pockets, dividing the month in four parts. The filing in this case would be as follows;

Voucher and receipt area;

Pocket #1 for the first 8 days of the month.

Pocket #2 for days 9 to 16.

Pocket #3 for days 17 to 24 and

Pocket #4 for the last days of the month.

The main idea is that people could file vouchers and receipts by date so that it will be easier to check billing information at the end of the month.

On the statement side there is a pocket for the statement and payment receipt. That statement folder area is to be use for filing the statement and the receipt for payment as prove for paying that statement bill. Since the statement comes most of the time in one or two letter side paper, the size for this pocket will be bigger than the voucher pocket so that it will fit in the statement.

1. What we claim as our invention is the design of the folder. There is not other folder out in the market specially designed to file credit card and debit statement. This completely new design could be compared to the simple POST IT by 3M. It is something simple, easy to manufacture, reliable, affordable, needed but never been done. Banks and other financial institutions will begin to produce this type of folder and send it to their clients to advertise their product.
